(19) United States
(12) Patent Application Publication
(10) Pub. No.: US 2009/0086032 A1
(43) Pub. Date: Apr. 2, 2009

(54) SYSTEM FOR DETECTING AND COMPENSATING CAMERA MOVEMENT AND A METHOD THEREOF

(75) Inventor: Yun-Chin Li, Taipei County (TW)

Correspondence Address: ROSENBERG, KLEIN & LEE, 3458 ELLICOTT CENTER DRIVE-SUITE 101, ELLICOTT CITY, MD, 21043, US

(73) Assignee: ALTEK CORPORATION, HSINCHU (TW)

(21) Appl. No.: 12/239,095

(22) Filed: Sep. 26, 2008

(30) Foreign Application Priority Data
Sep. 28, 2007 (TW) 96136139

(51) Int. Cl. H04N 5/228

(52) U.S. Cl. 348/208.1; 348/E05.031

(57) ABSTRACT

A system for detecting and compensating camera movement includes a pulse-sensing module and a process/control module. The pulse-sensing module senses the pulse and converts the pulse signal into a pulse count. The process/control module is coupled with the pulse-sensing module for receiving the pulse count and comparing the pulse count with a standard value. When the pulse count exceeds an allowable deviation of the standard value, the movement-compensating process is started to generate an alarm signal to notify the user to adopt a stable method to take a picture, and/or to cause the movement-compensating module to capture an image.

### BACKGROUND OF THE INVENTION

1. Field of the Invention

The present invention relates to a camera. In particular, this invention relates to a system and method for detecting and compensating camera movement while a photograph is taken.

2. Description of the Related Art

Image stabilization for digital still cameras is an important research topic. Some methods of movement compensation or image correction can solve the problem of the captured picture being blurred due to camera movement when pictures are taken at low illumination levels.

There are two main movement-compensating methods, including the optical system compensation and the image compensation calculation. The optical system compensation is based on the mechanical principle to make the lens set or the optical-sensing element perform a movement that is opposite to the external movement. Thereby, the camera movement is counteracted and the captured picture is sharp. The image compensation calculation uses a software application to perform a logic calculation. It uses the image overlapped exposure or the digital signal processing technology to estimate the dynamic movement of the image. Next, the rows and columns of the image array are rearranged and a sharp picture is captured.

Another core movement-compensating technology is the inertia sensing technology for detecting the movement. The camera usually uses movement-sensing elements, such as gyroscope or acceleration sensor, to detect camera movement. The compensation mechanism is started according to the sensing value that has been transmitted to the processor.

Because the dimensions of digital still cameras become smaller, the problem of camera movement becomes more serious. Therefore, a movement-compensating method is developed to solve the related problems.

### SUMMARY OF THE INVENTION

One particular aspect of the present invention is to provide a system for detecting and compensating camera movement and a method thereof. It uses a pulse-sensing module to obtain the user's pulse count. When the pulse count exceeds an allowable deviation of the standard value, the movement-compensating process is started to generate an alarm signal and/or alarm information to notify the user to use a more stable method for taking the picture, and/or cause the movement-compensating module to operate for capturing the image. Thereby, the problem of the captured image being blurred due to camera movement is avoided.

The present invention discloses a method for detecting and compensating camera movement. It solves the problem of the captured image becoming blurred due to involuntary camera movement in the following way. Firstly, the operator's pulse is sensed during capturing. Then the pulse is converted into a pulse count. The pulse count is compared with a standard value. When the pulse count exceeds an allowable deviation of the standard value, the movement-compensating process is started.

The present invention also discloses a system for detecting and compensating camera movement. The system for detecting camera movement includes a pulse-sensing module, and a process/control module. The pulse-sensing module senses the pulse of the user, and converts the pulse into a pulse count. The process/control module is coupled with the pulse-sensing module for receiving the pulse count, and compares the pulse count with a standard value. When the pulse count exceeds an allowable deviation of the standard value, the movement-compensation process is started.

In one embodiment, the system for detecting and compensating camera movement includes an alarm module coupled with the process/control module. The movement-detection process includes driving the alarm module to generate an alarm signal.

In a second embodiment, the camera has a display module coupled with the process/control module. The movement-detection process includes driving the display module to display an alarm information.

In a third embodiment, the camera has a movement-compensating module coupled with the process/control module. The movement-compensation process includes providing a compensation parameter to the movement-compensating module to cause the movement-compensating module to generate an image-obtaining signal to capture an image.

For further understanding of the invention, reference is made to the following detailed description illustrating the embodiments and examples of the invention. The description is only for illustrating the invention and is not intended limit the scope of the claim.

### BRIEF DESCRIPTION OF THE DRAWINGS

The drawings included herein provide a further understanding of the invention. A brief introduction of the drawings is as follows:

FIG. 1 is a schematic diagram of the system structure of the camera with a pulse-sensing function and the system for compensating movement of camera thereof of the present invention;

FIG. 2 is a schematic diagram of the appearance of the camera with a pulse-sensing function of the first embodiment of the present invention;

FIG. 3 is a schematic diagram of the appearance of the camera with a pulse-sensing function of the second embodiment of the present invention;

FIG. 4 is a schematic diagram of the appearance of the camera with a pulse-sensing function of the third embodiment of the present invention; and

FIG. 5 is a flow chart of the method for compensating camera movement of the present invention.

### DETAILED DESCRIPTION OF THE PREFERRED EMBODIMENTS

Because the pulse of the human being affects the ability of holding an object motionless by hand, the camera will move and the captured image will be blurred when the pulse count is too high. The system for detecting and compensating camera movement and method thereof of the present invention senses the user's pulse count and starts the movement-compensating process accordingly. Thereby, the problem of the captured image being blurred due to camera movement is improved.

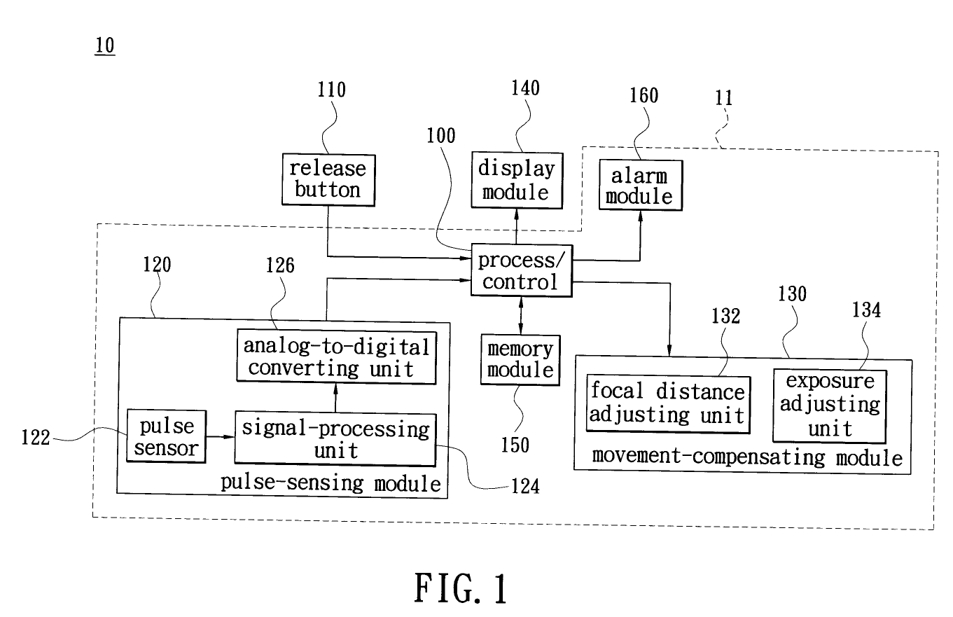

Reference is made to FIG. 1, which shows a schematic diagram of the system structure of the camera with a pulse-sensing function and the system for detecting and compensating camera movement of the present invention. The camera 10 has a movement-compensating system 11. The movement-compensating system 11 includes a process/control module 100, and a pulse-sensing module 120, a movement-compensating module 130, a memory module 150 and an alarm module 160 that are coupled with the process/control module 100. The camera 10 further has a release button 110 and a display module 140 respectively coupled with the process/control module 100.

The process/control module 100 is the control and logic calculation core of the camera 10. The release button 110 is pressed by the user to cause the process/control module 100 to perform an image-capturing procedure to capture the external image. The camera 10 further has a photo and electricity sensing module (not shown in the figure) that uses a CCD or CMOS image-sensing element to capture the image. The movement-compensating module 130 is driven by the process/control module 100 to compensate for camera movement and prevent the image from being blurred due to camera movement.

The movement-compensating module 130 can use the photo movement-compensating technology or the image-calculating technology to reduce the effects of camera movement. The movement-compensating module 130 in FIG. 1 uses the photo movement-compensating technology. The movement-compensating module 130 includes a focal distance adjusting unit 132 and an exposure adjusting unit 134 respectively controlled by the process/control module 100 for adjusting the imaging focal distance and the image exposure. The imaging focal distance can be changed by adjusting the distance between the lens and the image-sensing element. The image exposure is determined by the lens diaphragm, the camera shutter speed, and the sensitivity of the image-sensing element.

The release button 110 is a two-stage button structure. When the user softly presses the release button 110, the first-stage button of the release button 110 is enabled to generate a triggering signal and send the triggering signal to the process/control module 100 to start the sensitizing and focusing functions, etc. When the user continuously presses the release button 110, the second-stage button of the release button 110 is enabled to generate an imaging-capturing signal and send the imaging-capturing signal to the process/control module 100 to open the camera shutter to capture the image. The sensitizing and focusing technology of the camera is the prior art, and is not repeated here.

The display module 140 is a display interface of the camera 10, and is controlled by the process/control module 100. The memory module 150 is a storage unit of the camera 10 for storing the firmware, the reference values and the amended values required for the operation, and the product information. The alarm module 160 is controlled by the process/control module 100 to generate an alarm signal to inform the user that the camera 10 has some abnormal status. In an embodiment, the alarm module 160 includes a lighting element (such as an LED) that is driven by the process/control module 100 to light for generating an alarm signal. In another embodiment, the alarm module 160 includes a buzzer that is enabled by the process/control module 100 to generate an alarm sound.

The pulse-sensing module 120 is used for obtaining the user's pulse, converting the pulse into a pulse count, and outputting the pulse count to the process/control module 100. The process/control module 100 compares the pulse count with a standard value that is stored in the memory module 150 to judge whether the pulse count exceeds the standard value or not. When the pulse count exceeds an allowable deviation of the standard value, the movement-compensating process is started to prevent the image from being blurred.

In one embodiment, the standard value is a statistical value, and the allowable deviation is a percentage of the standard. For example, when the allowable deviation is 10% of the standard value and the standard value is 80, the upper limit of the allowable range is 88. The standard value and the allowable deviation are recorded into the memory module 150 when the camera 10 is manufactured.

In another embodiment, the standard value can be changed by the user. The standard value can be inputted or modified via the operation interface (not shown in the figure) of the camera 10, and is stored in a customized area of the memory module 150.

In a further embodiment, the movement-compensating system 11 further includes a movement-sensing unit (not shown in the figure) to sense the movement of the camera 10. When the user holds the camera 10 in a setting mode, the process/control module 100 automatically calculates a set of standard values and the allowable deviation according to the measured pulse count and the movement of the camera 10, and stores the set of standard values and the allowable deviation on a customized area of the memory module 150.

Furthermore, the measured pulse count can enhance the control ability of the movement-compensating module 130. A general optical movement-compensating system will compensate the movement according to the user's movement. However, when the camera movement is heavy or irregular, the optical movement-compensating system will fail because the movement cannot be compensated immediately. When the movement-compensating module 130 includes a plurality of compensation mechanisms and a plurality of compensation parameters stored in the memory module 150, the process/control module 100 can output the optimum compensation parameter to control the compensation mechanism according to the movement. Therefore, the movement-compensation of the movement-compensating module 130 is enhanced.

In one embodiment, the first-stage button of the release button 110 is enabled to generate and transmit the triggering signal to the process/control module 100, the process/control module 100 causes the pulse-sensing module 120 to obtain the pulse count. Then the pulse count is transmitted to the process/control module 100. The process/control module 100 checks whether the pulse count exceeds the allowable deviation of the standard value.

In a preferred embodiment, the movement-compensating process can be divided into two parts. When the pulse count exceeds the allowable deviation of the standard value, the process/control module 100 drives the alarm module 160 to generate the alarm signal or drives the display module 140 to display the alarm information to notify the user that the pulse count exceeds the allowable deviation of the standard value and the user's hand vibrates. If the user presses the release button 110 to capture the image, the image will be blurred due to movement. At this time, the user needs to change their gesture to firmly hold the camera, or use a tripod to fasten the camera 10 to capture the image.

In order to prevent the user from ignoring the alarm signal and pressing the release button 110 to capture the image, the process/control module 100 controls the photo mode of the movement-compensating module 130 when the user's pulse count exceeds the allowable deviation of the standard value. The process/control module 100 outputs the compensation parameters of the movement photo mode stored in the memory module 150 to the focal distance adjusting unit 132 and an exposure adjusting unit 134. It locks the focal distance adjusting unit 132 or controls the diaphragm, the camera shutter speed and the film speed to capture the sharp image. In addition to the photo movement-compensating method shown in FIG. 1, the movement-compensating module 130 can be implemented in other ways, such as adopting a continuous-photo mode to capture a plurality of images on the scene or performing a compensation calculation to the image signals. Thereby, a sharp image is captured.

The pulse-sensing module 120 can be a built-in module or an external module of the camera 10. The pulse-sensing module 120 has a pulse sensor 122, a signal-processing unit 124, and an analog-to-digital converting unit 126. The pulse sensor 122 is a resistor-type pulse sensor, a capacitor voltage sensor, a photo pulse sensor, or another sensing element that can sense the pulse. According to the sensing methods, a voltage signal or a current signal is generated for the pulse. The signal-processing unit 124 is coupled with the pulse sensor 122 for receiving the pulse and amplifying and filtering the pulse. The analog-to-digital converting unit 126 is coupled with the signal-processing unit 124 for converting the pulse into a digital pulse count.

The pulse count does not refer to the user's real pulse frequency. The pulse count is a data that can be identified and processed by the process/control module 100.

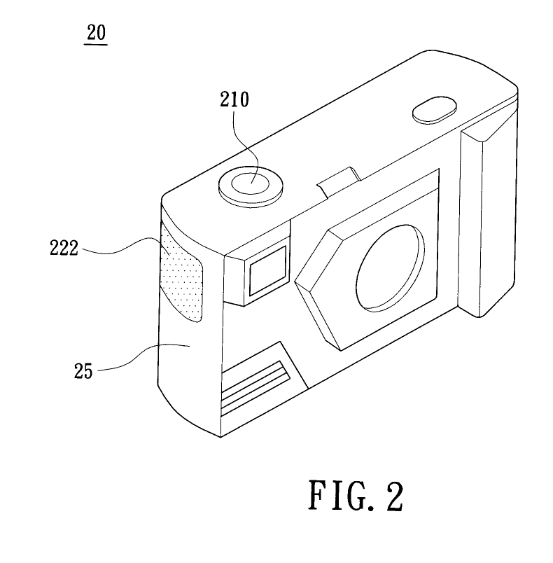

Reference is made to FIGS. 2, 3 and 4. These three diagrams show the three embodiments of the appearance of the camera with a pulse-sensing function for illustrating the concept of the present invention.

In the camera 20 shown in FIG. 2, the pulse sensor 222 is located at the external surface of the camera body 25 that is adjacent to the release button 210. When the user holds the camera 20 and presses the release button 210, the palm or fingers also tightly leans against the pulse sensor 222. Therefore, the camera can use the pulse sensor 222 to sense the user's pulse to obtain the pulse count.

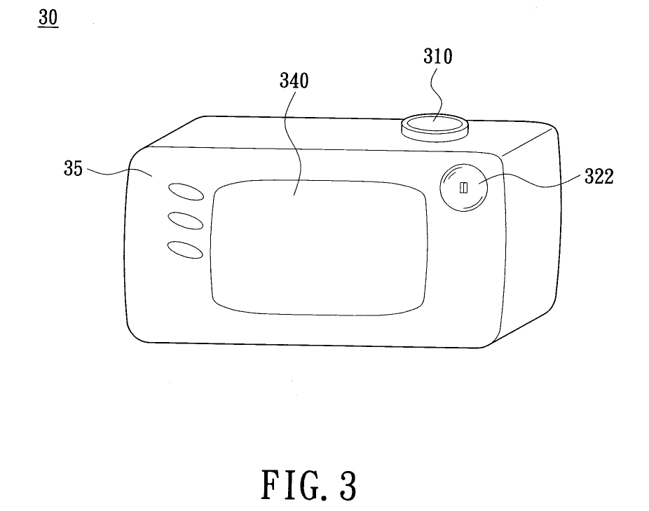

In the camera 30 shown in FIG. 3, the pulse sensor 322 is located at a surface of the camera body 35 that is adjacent to the display module 340. In this embodiment, the pulse sensor 322 is a photo pulse sensor. The photo pulse sensor uses IR to detect the flow of blood to obtain the pulse. Therefore, it is located at the location that the fingers can contact it. In FIG. 3, when the user presses the release button 310, the thumb also presses the pulse sensor 322.

FIGS. 2 and 3 are the embodiments that the pulse sensor is built-in the camera. The location of the pulse sensor can be changed according the application. For example, in an embodiment, the pulse sensor can be combined with the release button, and then is located at the upper surface. The locations of the pulse sensor in FIGS. 2 and 3 are two examples, and are not used for limiting the scope of the present invention.

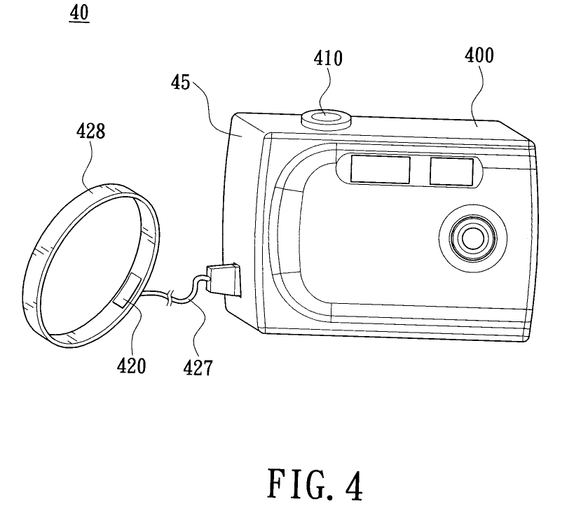

In FIG. 4, the pulse sensor 420 is an external element of the camera 40. In this embodiment, the pulse sensor is located at a fastening belt 428, and is connected with the camera body 45 via a transmission wire for transmitting signals. When the user takes a picture, the fastening belt 428 is put around the wrist or the finger. Therefore, the pulse sensor 420 can sense the pulse to obtain the pulse count, and the pulse count is transmitted to the control core in the camera body 45 via the transmission wire 427.

How to obtain the user's pulse by the pulse sensor and convert the pulse into the pulse count is prior art and thus not illustrated here.

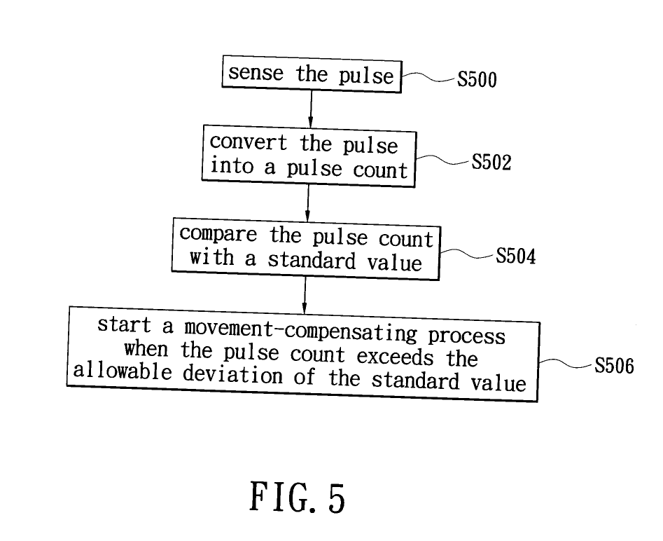

Reference is made to FIG. 5, which shows a flow chart of the method for detecting and compensating camera movement of the present invention. The related system structure is shown in FIG. 1. The method for detecting and compensating camera movement includes the following steps.

Firstly, the pulse-sensing module 120 senses the pulse (S500).

Next, the pulse-sensing module 120 converts the pulse into a pulse count, and transmits the pulse count back to the process/control module 100 (S502).

The process/control module 100 compares the pulse count with a standard value (S504).

When the pulse count exceeds an allowable deviation of the standard value, the process/control module 100 starts the movement-compensating process (S506). Thereby, the problem of a blurred image due to camera movement is eliminated.

In one embodiment, the movement-compensating process includes driving the alarm module 160 to generate an alarm signal and/or driving the display module 140 to display the alarm information by the process/control module 100 to notify the user to take a stable method to take a picture. In another embodiment, the movement-compensating process includes outputting a compensation parameter to the movement-compensating module 130 by the process/control module 100 to cause the movement-compensating module 130 to use a vibration-photo mode to capture a sharp image. In a preferred embodiment, the process/control module 100 simultaneously controls the alarm module 160, the display module 140 and the movement-compensating module 130 to perform the movement-compensating process.

Furthermore, the camera with the pulse-sensing function can be used as a tool for measuring the pulse to display the user's pulse frequency. Reference is made to FIG. 1 again. After the pulse-sensing module 120 outputs the pulse count to the process/control module 100, the process/control module 100 can perform a process to the pulse count. In one embodiment, the process/control module 100 processes the pulse count to obtain the pulse frequency. In another embodiment, when the pulse count does not match the standard value, the process/control module 100 drives the alarm module to generate an alarm signal. In a further embodiment, the process/control module 100 transmits the pulse count to the memory module 150, and stores it in the memory module 150. In a further embodiment, the process/control module 100 writes the user's pulse frequency into the image signal so that the user's pulse frequency is displayed on the captured image.

The system for detecting and compensating camera movement and a method thereof of the present invention use a pulse-sensing module to sense the user's pulse and obtain the pulse count. When the pulse count exceeds an allowable deviation of a standard value, the movement-compensating process is started to generate an alarm signal and/or an alarm information to notify the user to use a stable method for taking the picture, and/or to enable the movement-compensating module in aid of capturing the image. Thereby, the problem of a blurred image due to camera movement is avoided.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A method for detecting and compensating camera movement for solving the problem of the captured image being blurred due to camera movement, comprising:
sensing a pulse;
converting the pulse into a pulse count;
comparing the pulse count with a standard value; and
starting a movement-compensating process when the pulse count exceeds an allowable deviation of the standard value.

2. The method for detecting and compensating camera movement as claimed in claim 1, further comprising the step:
providing the camera with a pulse-sensing module and a process/control module for sensing the pulse by the pulse-sensing module, converting the pulse into the pulse count and outputting the pulse count to the process/control module, and checking whether the pulse count exceeds the allowable deviation of the standard value or not.

3. The method for detecting and compensating camera movement as claimed in claim 2, wherein the process/control module is triggered by a signal to cause the pulse-sensing module to sense the pulse count.

4. The method for detecting and compensating camera movement as claimed in claim 1, wherein the camera has a movement-compensating module, and the movement-compensating process comprises the following steps:
setting a compensation parameter according to the pulse count; and
transmitting the compensation parameter to the movement-compensating module for cooperating with an image-capturing signal to capture an image.

5. The method for detecting and compensating camera movement as claimed in claim 1, wherein the camera has an alarm module, and the movement-compensating process comprises the following step:
driving the alarm module to generate an alarm signal.

6. The method for detecting and compensating camera movement as claimed in claim 1, wherein the camera has a display module, and the movement-compensating process comprises the following step:
driving the display module to generate an alarm information.

7. A system for detecting and compensating camera movement, comprising: a pulse-sensing module for sensing a pulse and converting the pulse into a pulse count; and
a process/control module coupled with the pulse-sensing module for receiving the pulse count and comparing the pulse count with a standard value, wherein a movement-compensating process is started when the pulse count exceeds an allowable deviation of the standard value.

8. The system for detecting and compensating camera movement as claimed in claim 7, wherein the camera includes a release button coupled with the process/control module, the release button being able to generate a triggering signal and an image-capturing signal.

9. The system for detecting and compensating camera movement as claimed in claim 8, wherein the process/control module is triggered by a triggering signal to cause the pulse-sensing module to sense the pulse.

10. The system for detecting and compensating camera movement as claimed in claim 7, wherein the camera includes a movement-compensating module coupled with the process/control module, and the movement-compensating process comprises generating a compensation parameter and transmitting the compensation parameter to the movement-compensating module by the process/control module for causing the movement-compensating module to cooperate with the image-capturing signal to capture an image.

11. The system for detecting and compensating camera movement as claimed in claim 10, wherein the movement-compensating module comprises a focal distance adjusting unit that is controlled by the compensation parameter.

12. The system for detecting and compensating camera movement as claimed in claim 10, wherein the movement-compensating module comprises an exposure adjusting unit that is controlled by the compensation parameter.

13. The system for detecting and compensating camera movement as claimed in claim 12, wherein the exposure adjusting unit is caused by the compensation parameter to adjust the diaphragm and/or the camera shutter speed.

14. The system for detecting and compensating camera movement as claimed in claim 7, further comprising an alarm module coupled with the process/control module, and the movement-compensating process comprises driving the alarm module to generate an alarm signal.

15. The system for detecting and compensating camera movement as claimed in claim 14, wherein the alarm module comprises a lighting element, and the process/control module causes the lighting element to light up.

16. The system for detecting and compensating camera movement as claimed in claim 14, wherein the alarm module comprises a buzzer, and the process/control module drives the buzzer to issue an alarm sound.

17. The system for detecting and compensating camera movement as claimed in claim 7, wherein the camera has a display module coupled with the process/control module, and the process/control module drives the display module to display alarm information.

18. The system for detecting and compensating camera movement as claimed in claim 7, wherein the pulse-sensing module comprises:
a pulse sensor for sensing the pulse;
a signal-processing unit coupled with the pulse sensor for amplifying and filtering the pulse; and
an analog-to-digital converting unit coupled with the signal-processing unit for converting the pulse into a digital pulse count.

19. The system for detecting and compensating camera movement as claimed in claim 18, wherein the pulse sensor is a resistor-type pulse sensor, a capacitor voltage sensor, or a photo pulse sensor.

20. The system for detecting and compensating camera movement as claimed in claim 18, wherein the camera has a camera body, the pulse-sensing module is a built-in module of the camera, and the pulse sensor is located on the surface of the camera body.

21. The system for detecting and compensating camera movement as claimed in claim 18, wherein the camera has a release button, and the pulse-sensing module is located at the release button.

22. The system for detecting and compensating camera movement as claimed in claim 7, wherein the camera has a camera body, the pulse-sensing module is an external module located at outside of the camera body, and the pulse-sensing module is coupled with the camera body via a transmission wire for transmitting the pulse count to the process/control module.
